(19) United States
(12) Patent Application Publication
(10) Pub. No.: US 2026/0134394 A1
(43) Pub. Date: May 14, 2026

(54) SYSTEMS AND METHODS INCLUDING ADAPTIVE EDUCATIONAL WORKFLOWS FOR AGENTIC AI LITERACY, SOFT SKILLS MASTERY, AND CREATIVE ENTREPRENEURSHIP

(71) Applicant: 301 AD Corporation, Agoura Hills, CA (US)

(72) Inventors: Alex Boghossian, Agoura Hills, CA (US); Erica Der Mesropian, Agoura Hills, CA (US); Zarik Boghossian, Glendale, CA (US)

(21) Appl. No.: 19/386,168

(22) Filed: Nov. 11, 2025

Related U.S. Application Data
(60) Provisional application No. 63/719,509, filed on Nov. 12, 2024.
(60) Provisional application No. 63/799,060, filed on May 2, 2025.

(51) Int. Cl. G06Q 10/10; G06F 8/30; G06Q 50/20

(52) U.S. Cl. CPC G06Q 10/103; G06F 8/30; G06Q 50/205

(57) ABSTRACT

A computer-implemented method of generating a presentation digital file and associated software application includes generating a pitch digital file; evaluating the digital file to determine a vector score or value for the digital file; determining a next artificial intelligence (AI) software tool or agent to initiate, execute or deploy with respect to the pitch digital file; generating a formal specification file based at least in part on the pitch digital file; automatically reviewing the formal specification file to determine quality parameters associated with the formal specification file; determining a second AI software tool or agent for a build and deployment phase to perform operations on the formal specification file; and generating via the build and deployment stage of the readiness workflow process, the most viable product (MVP) digital file from the formal specification file.

### RELATED APPLICATIONS

This application claims priority to U.S. provisional patent application serial Nos. 63/719,509, filed Nov. 12, 2024, entitled “301 AD: Bridging the Gap Between Education and Employment in Armenia Using Generative AI Tools,” and 63/799,060, filed May 2, 2025, entitled “Adaptive Educational Workflows for Agentic AI Literacy, Soft Skills Mastery, and Creative Entrepreneurship,” the entirety of which are both hereby incorporated by reference.

### BACKGROUND

A foremost problem that exists in the world today is a skills mismatch between jobseekers and modern employers. This problem exists in many advanced countries, including, but not limited to, the United States of America (USA) and Armenia. That challenge remains which 301 AD aims to focus on solving for the betterment of such countries—but the rapid rise of Agentic AI in the last year has widened the overall opportunity (and the gap) far beyond traditional employment.

### BRIEF DESCRIPTION OF THE DRAWINGS

A better understanding of the features, advantages and principles of the present disclosure will be obtained by reference to the following detailed description that sets forth illustrative embodiments, and the accompanying drawings of which:

FIG. 1 illustrates a first process or RenAIssance workflow process according to exemplary embodiments.

IG. 2 illustrates a SAL process of the enhanced project or product AI workflow process according to exemplary embodiments.

FIG. 3 illustrates a flowchart for the Tool Chain Orchestrator process according to exemplary embodiments.

FIG. 4 illustrates a safeguard or Trauma Informed Reintegration process and modules according to exemplary embodiments.

FIG. 5 illustrates an example implementation of many processes of an enhanced product AI workflow process for a representative organization according to exemplary embodiments.

FIG. 6 illustrates a flowchart outlining implementation of many processes of an enhanced product AI workflow process for a representative organization according to exemplary embodiments.

FIG. 7 illustrates a flowchart outlining implementation of many processes of an enhanced product AI workflow process for a representative organization according to exemplary embodiments.

FIG. 8 illustrates a trauma—informed reintegration pilot process according to exemplary embodiments. and

FIG. 9 illustrates a block diagram of a computing environment according to exemplary embodiments.

### DETAILED DESCRIPTION

The following detailed description provides a better understanding of the features and advantages of the inventions described in the present disclosure in accordance with the embodiments disclosed herein. Although the detailed description includes many specific embodiments, these are provided by way of example only and should not be construed as limiting the scope of the inventions disclosed herein.

Anyone, anywhere can turn a project and/or product into a revenue-generating product in days, weeks, or months—if they can wield AI agents effectively and possess the proper soft-skills to present their vision and market their product or service with confidence. Most aspiring founders—whether that be an Armenian, American or other founders around the world—lack structured, universally standard, pathways that equally prioritize Agentic AI Literacy+Entrepreneurial Soft-Skills Development above all else. In additional embodiments, vulnerable and under-represented groups (e.g., domestic-violence survivors, orphans, displaced individuals living in foster-care communities) face additional barriers that require trauma-informed, multilingual, and privacy-centric learning environments.

301 AD's refined mission is therefore to cultivate creative entrepreneurs—not merely better employees—through a technology-driven and automated process including: (a) Specialized workflows that sequence best-in-class Generative AI and Agentic AI tools (ideation to documentation to design to coding to deployment to pitching) to entrepreneur; (b) Utilize adaptive orchestration engines that personalize the journey, track “RenAIssance™ Readiness” and gate progression of the entrepreneurs based on mastery of skills learned through implementation of the tools; (c) Soft-Skill Accelerator Loops that use Large Language Models (“LLM”) analytics to coach communication, confidence, and resilience—skills essential for founders and innovators; and (d) Trauma-informed variants of these programs, like the SafeYOU “SAFE SKILLS” program, ensuring inclusivity for survivors and other at-risk learners.

In this description, automatic software programs and/or hybrid programs (e.g., including automatic software and software or programs requiring human intervention) may implement, execute and/or initiate the phases, steps and/or processes described below. These automatic software programs may be referred to as modules, programs, subroutines and/or other similar terms. The enhanced product or project AI workflow process described herein addresses the problems described above and provides entrepreneurs, founders, users and/or students with the ability to create structured, universally standard, pathways that equally prioritize Agentic AI Literacy+Entrepreneurial Soft-Skills Development. Founders, users, entrepreneurs and/or students may be utilized interchangeably throughout this specification.

In exemplary embodiments, a first process of an enhanced project or product AI workflow process may cultivate creative entrepreneurship by receiving project or product parameters and generating a deployed most viable product (in a most viable product digital file) by utilizing generative artificial intelligence (AI) and Agentic AI tools, while at the same time surfacing, creating or generating soft-skill prompts at process checkpoints. In some circumstances, the first process may be referred to a RenAIssance™ Readiness Workflow (RRW) process. In exemplary embodiments, the first or RRW process may be a scripted, four-phase process that cultivates creative entrepreneurship. In exemplary embodiments, the first or RRW process may be fully automated and/or a process monitored by AI. In some cases, the first or RRW process may be used by human instructors teaching in-person and/or online. In exemplary embodiments, the RRW or first process may be condensed or modified and in some cases only some of the steps or phases may be utilized in specific implementations.

In exemplary embodiments, a second process in the enhanced product AI workflow process may include an automated feedback mechanism which utilizes large language model (LLM) evaluation to measure, coach and/or teach communication, creativity and/or resilience to entrepreneurs or business people. In some embodiments, this second process may be referred to as a Soft-Skill Accelerator Loop (SAL). The second or SAL process may be fully automated. In some embodiments, this second or SAL process may be utilized by human instructors to measure, score, teach and/or coach these essential soft skills in-person and/or online. In exemplary embodiments, the second or SAL process may be condensed or modified and in some cases, only some of the steps or phases may be utilized in specific implementations.

In exemplary embodiments, a third process in the enhanced product AI workflow process may generate composite scores. In exemplary embodiments, the composite score(s) may be calculated after the third process automatically analyzes prompt quality, code accuracy, deployment success of the and presentation sentiment for the entrepreneur or founder. In some embodiments, the third process may be referred to as a RenAIssance Readiness Index (RRI). Not all of the factors mentioned immediately above may be utilized in calculating or generating the RRI value or parameter.

In exemplary embodiments, a fourth process in the enhanced product AI workflow process may include a rules engine that monitors and/or watches progress of an entrepreneur or business professional and automatically decides which AI or web tool should be triggered and/or initiated next in the automated AI workflow process. As an illustrative example, the third process may decide between ChatGPT, CodeGuide, Lovable and/or Cursor as a next AI tool to be utilized by the entrepreneur or business professional. In exemplary embodiments, the third process may be referred to as a Tool-Chain Orchestrator (TCO). In some embodiments, instructors or teaching professionals may override the third-process's determinations or decisions. However, the core sequencing, gating and/or telemetry collection may be handled by this adaptive orchestration layer. In exemplary embodiments, the TCO may be limited or throttled to a smaller number of AI agents. In some embodiments, the fourth process may be implemented a number of times in a workflow process.

In exemplary embodiments, a fifth process in an enhanced product AI workflow process may include a multimodal framework that blends a vision-mapping process, an AstroCartography process, and/or a new sub-conscious re-patterning loops into a new richer module to accelerate identity-level change. In exemplary embodiments, the fifth process may be referred to as an Enlightenment & Empowerment Mapping (EEM) process. In some embodiments, the EEM process may include multiple phases and/or steps and in other embodiments, only one phase, step or loop may be utilized in the fifth or EEM process.

In exemplary embodiments, a sixth process in an enhanced product AI workflow process may include an automated adaptive workflow that assesses passions or skills, generates personalized career maps, provides AI-mentor coaching for resume building, and/or ranks candidates for donor-funded internships or entrepreneurship grants. In some embodiments, the sixth process may be referred to as a Career-Empowerment Pathway (CEP). In some embodiments, the sixth process may be a hybrid adaptive workflow that is automated and/or also utilizes manual intervention or overriding. In some embodiments, the CEP or sixth process may include multiple phases and/or steps and in other embodiments, one or two phases, steps or loops may be utilized in the sixth or CEP process.

In some additional embodiments, an additional process in the enhanced product workflow process may include a safeguard mode for all of the above-identified processes in order to provide safeguards for individuals and/or subjects that may need protection for prying eyes or third parties. In some embodiments, the additional process may be referred to as Trauma Informed Reintegration (TIR) process. In some embodiments, the additional process or the TIR process may be a safeguarded mode for the RRW, SAL, TCO, RRI, EEM and/or CEP process and may provide additional anonymity, trigger filtering, and empowerment tools generation for victims of emotional, physical, and/or mental trauma, as well as underprivileged individuals & communities.

The processes, phase or steps described above may not be implemented in consecutive steps. In exemplary embodiments, the processes, phases or steps may be implemented and/or executed in many different orders where different steps from one process or phase are in performed or executed in between steps of another process or phase. As an illustrative example, in between a design and documentation phase or step and a build and deploy stage or step of the RRW process, a tool chain orchestrator step or phase may be executed. Similarly, in between a foundation and inspiration step or phase and design and deployment step or phase of the RRW process, the SAL process (or one of the steps or phases of SAL process) may be implemented or executed.

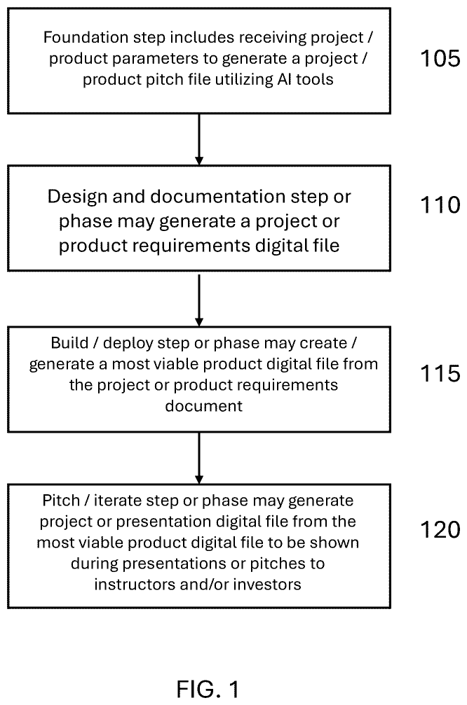

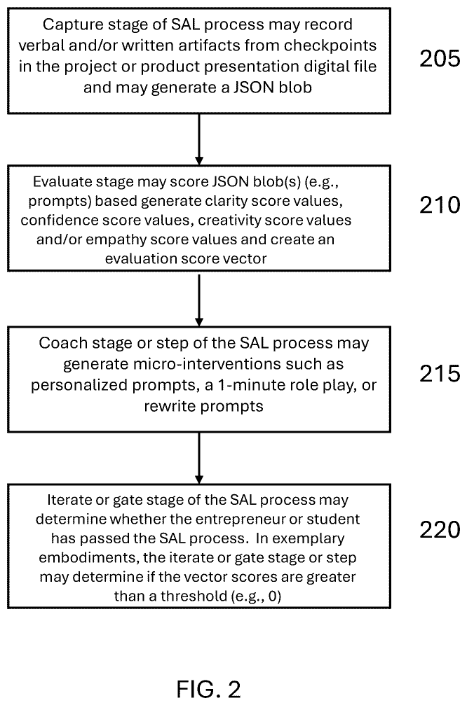

FIG. 1 illustrates a first process or RenAIssance Readiness workflow (RRW) process according to exemplary embodiments. In FIG. 1, the first or RRW process may include four automatic or hybrid steps or phases. In exemplary embodiments, a first step or phase 105 may be a foundation or inspiration step, phase or module, a second step, phase or module 110 may be a design and/or documentation step or phase, a third step, phase or module 115 may be a build, generate and/or deploy step or phase, and a fourth step, phase or module 120 may be a pitch or iterate step or phase. In exemplary embodiments, the first step, phase or module 105 may include receiving project and/or product parameters and generating a project or product pitch file utilizing AI tools. The first step, phase or module (foundation or inspiration step or phase) 105 may include utilizing the AI tools to stimulate ideation or creation of the project and/or product parameters, brainstorming or creating most viable product features, and/or benchmark market needs for the project and/or product parameters. In exemplary embodiments, the AI tools may include CHAT-GPT Voice and/or Perplexity although other large language models ideation engines may be utilized. In exemplary embodiments, the first step, phase or module (a foundation or inspiration step or phase) 105 may output a multimedia project or product pitch digital file. In exemplary embodiments, a multimedia project or product pitch digital file may be 30 to 60 seconds in duration and focused on problem opportunities and how the project or product addresses the problem.

In exemplary embodiments, the second step, phase or module (design and documentation step or phase) 110 of the RRW process may convert the project or product parameters and/or multimedia project or product digital file to a project or product formal specification file. In exemplary embodiments, the design and documentation step or phase 110 may generate a project or product formal specification or requirements digital file. In exemplary embodiments, AI tools utilized in the second step, module or phase 110 may include CodeGuide and/or Miro, although other AI product requirements document generators may be utilized. In exemplary embodiments, an additional step in the second (design and documentation) process or step 110 may further include peer review and/or constructive feedback sessions.

In exemplary embodiments, a build and deploy step, phase or module 115 of the RRW process may create and/or generate a most viable product digital file from the project or product requirements digital file or formal specification file. In exemplary embodiments, the project or product requirements digital file (or formal specification file) may be input into Lovable™ (or other AI assisted user interface/user experience (UI/UX) design tool, Cursor™ (or other AI coding assistant), and/or Supabase™. In exemplary embodiments, the most viable product digital file may be deployed by Vercel™ (or other AI deployment software). In exemplary embodiments, the most viable project digital file may have been refined through a live demo & question and answer session and may include added resilience under real-time debugging.

In exemplary embodiments, a pitch and/or iterate step, phase or module 120 of the RRW process may generate a project or presentation digital file from the most viable product digital file to be shown during presentations or pitches to instructors and/or investors. In exemplary embodiments, the pitch and/or iterate step, phase or module 120 may also refine the project or product presentation digital file narrative and validate the project or product presentation digital file. In addition, in exemplary embodiments, the entrepreneur or founder may prepare the project or product presentation digital file for presentation to instructors and/or investors. In exemplary embodiments, the pitch and/or iterate step, phase or module 120 may utilize Gamma™ (or other AI assisted presentation/slides generator) or Rapid™ (or other rapid tweaks program). In exemplary embodiments, the project or product presentation digital file may be a three-minute investor style pitch with a storytelling rubric.

In exemplary embodiments, the second step or soft-skill accelerator loop (SAL) of an enhanced product AI workflow process may include four steps, stages or modules, although other steps, stages or modules may be included and/or added. FIG. 2 illustrates a SAL process of the enhanced project or product AI workflow process according to exemplary embodiments. In exemplary embodiments, the second step or soft-skill accelerator loop may include a capture step, phase or module 205, an evaluation step, phase or module 210, a coach step, phase or module 215, and/or a iterate or gate step, phase or module 220.

In exemplary embodiments, the second or SAL process may be an automatic feedback mechanism that utilizes a large language model (LLM) evaluation to measure and coach communication, creativity and/or resilience. In exemplary embodiments, human instructions may also, in combination with or in addition to the automatic SAL process, utilize the second or SAL process to measure and coach the essential soft-skills either in-person and/or online.

In exemplary embodiments, the capture stage, step or module 205 of the SAL process may record verbal and/or written artifacts from checkpoints in the project or product presentation digital file and may generate one or more JSON blobs (which may include text, a timestamp, and/or a learner identifier). In exemplary embodiments, the capture stage, step or module 205 of the SAL process may utilize AI tools such as Google Speech-to-Text, Whisper and/or ChatGPT-transcription to generate the JSON blob(s) or input prompts to AI agents.

In exemplary embodiments, the evaluate stage, step or module 210 of the SAL process may score the JSON blob(s) associated with the input prompts and/or the prompts themselves to generate clarity score values, confidence score values, creativity score values and/or empathy score values and create an evaluation score vector including the above-identified score values. In other words, the evaluate stage, step or module 210 is automatically evaluating the prompts in the above-identified areas (e.g., clarity, confidence, creativity or empathy) and generating associated values or scores. In exemplary embodiments, the evaluate stage, step or module 210 may utilize a custom BERT classifier, or GPT-4o evaluation prompts (or other assistive AI tools) to generate the evaluation score vector.

In exemplary embodiments, the coach stage, step or module 215 of the SAL process may generate micro-interventions such as personalized prompts, a 1-minute role play, or rewrite prompts. In exemplary embodiments, the coach stage, step or module 215 may utilize AI assistive tools such as ChatGPT-4o and/or a rehearsal bot or automatic software program.

In exemplary embodiments, the iterate or gate stage, step or module 220 of the SAL process may determine whether the entrepreneur or student has passed the SAL process. In exemplary embodiments, the iterate or gate stage, step or module 220 determines if the vector scores are greater than a threshold (e.g., 0) and if they are not, then the iterate or gate stage, step or module 220 may loop and be performed iteratively until the vector scores are greater than the threshold or zero. In exemplary embodiments, if the vector scores are greater than zero, a pass/fail flag for the student or entrepreneur in the system. In exemplary embodiments, in a hybrid mode, the instructor personally may present the vector scores on a dashboard, deliver live feedback and/or manually set a pass flag in the system. In exemplary embodiments, the vector S scores may be utilized in additional steps or processes.

In exemplary embodiments, a third process of the enhanced AI workflow process is the generating of the renaissance readiness index (RRI). In exemplary embodiments, RRI step, phase or module may include scoring outputs of the first step (Renaissance Readiness Workflow) and the second step (Soft-Skill Accelerator Loop) to automatically calculate a readiness score or value for the student or entrepreneur utilizing the enhanced product AI workflow process. In exemplary embodiments, the RRI step, phase or module may include software resident and/or stored in the RenAIssance curriculum platform or the enhanced workflow process system and/or platform. In exemplary embodiments, the RRI software may automatically calculate a RRI score or value based at least in part on prompt quality, code accuracy, deployment success and/or presentation sentiment of the prompt inputs that have been generated by the prior stages, steps or modules of the RRW process and/or the SAL process. As an illustrative example, a deployment success score, parameter or value may be automatically calculated and/or determined from continuous integration and/or continuous deployment (CI/CD) logos and/or platform APIs (including but not limited to Vercel, Supabase, and/or Replit). In some implementations, a successful push of a functional most viable project or product file may return a binary success flag (1=pass, 0=fail) or ratio-based pass rate across iterations. As an illustrative example, the presentation sentiment value, score or parameter may be calculated and/or derived from large-language-model (LLM) tone analysis of a final project or product digital presentation file (and/or specifically a final pitch's transcript and/or recorded audio file). In other cases, the prompts input into the RRW and/or the SAL process may be evaluated to generate the or calculate the presentation sentiment value, score or parameters. These sentiment metrics represent an audience-perceived tone (e.g., confidence, persuasiveness, and/or emotional engagement) as interpreted automatically by an AI agent evaluator and not self-reported by the student, founder or entrepreneur. In exemplary embodiments, the RRI software in the RenAIssance curriculum platform may automatically calculate the RRI score utilizing the following formula: RRI=w1xPromptQuality+w2xCodeAccuracy+w3xDeploymentSuccess+w4xPresentationSentiment.

As an illustrative example, the table below includes example weightings from prompt quality, code accuracy, deployment success and/or presentation sentiment. In exemplary embodiments, an AI tool such as GPT-4o, GPT-o3 and/or GPT-o4-mini may evaluate the project or product presentation digital file and/or JSON blob and utilize a rubric scoring of 1-10 to generate a prompt quality score or value. In exemplary embodiments, an AI tool such as unit-test suite pass ratio may evaluate code generated by the prompts, the project or product presentation digital file and/or JSON blob to generate a code accuracy score or value. In exemplary embodiments, a CI/CD log tool may evaluate the prompts, project or product presentation digital file and/or JSON blob to generate a deployment success score or value. In exemplary embodiments, an AI tool such as GPT-4o tone analysis software may evaluate prompts from the project or product presentation digital file and/or JSON blob to generate a presentation sentiment score or value. In exemplary embodiments, an Admin user interface (UI) in the Renaissance platform may allow admin personnel and/or may allow the automatic adjustment or tuning of weights per cohort (e.g., entrepreneur or founder). In other words, for different users and/or different business environments, the Renaissance platform may utilize different weights depending on the situation. In exemplary embodiments, the RRI score or value may feed back into and/or may be automatically input into the fourth process or Tool Chain Orchestrator (TCO) process for adaptive gating and/or into alumni dashboards for talent matching. In exemplary embodiments, a default weight for the PromptQuality factor may be 0.25, a default weight for the CodeAccuracy factor may be 0.30, a default weight for the DeploymentSuccess factor may be 0.25, and/or a default weight for the PresentationSentiment factor may be 0.20.

In exemplary embodiments, a fourth process or a Tool-Chain Orchestrator (TCO) process may be a rules engine that monitors progressions of users (e.g., founders or entrepreneurs) and automatically determines which AI or web software agent or program should be triggered next in the enhanced product AI workflow process. As an illustrative example, the fourth or TCO process may determine that the following AI agents or software may be utilized in the following order (e.g., ChatGPT->CodeGuide->Lovable->Cursor) for a specific user or entrepreneur.

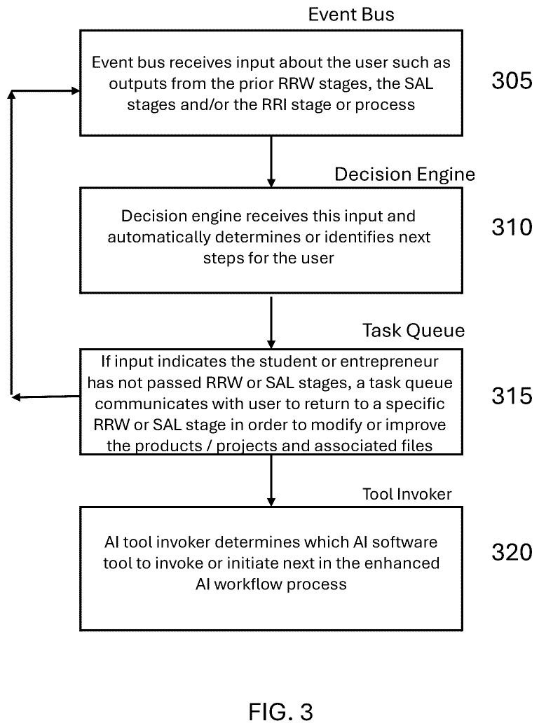

As a reminder that the different process steps or stages are not linear in nature, the Tool Chain Orchestrator may utilize output from the third or Renaissance Readiness Index step or stage or alternatively may be utilized in between steps, stages or modules in the first or Renaissance Readiness Workflow process and/or steps, stages or modules in the second or SAL process. FIG. 3 illustrates a flowchart or block diagram for the Tool Chain Orchestrator process according to exemplary embodiments. In exemplary embodiments, an event bus 305 receives input about the user such as outputs from the prior RRW stages, steps or modules, the SAL stages, steps or modules and/or the RRI stage, process or module. In exemplary embodiments, the outputs from these stages, steps or modules are automatically input into a decision engine 310. In exemplary embodiments, the decision engine 310 receives this input and automatically determines or identifies next steps for the user, which may be provided to the task queue 315. In exemplary embodiments, rules in the decision engine 310 may be expressed in JSON and invoking or adding a new AI tool or software may require that only a new AI tool_id be created and added to the Tool Invoker 320 microservice in the Renaissance platform and/or system. In exemplary embodiments, in the case where the input indicates the student or entrepreneur has not passed specific RRW or SAL stages, steps or modules (or has a low RRI score or value), a task queue 315 may communicate with the student, user, founder or entrepreneur to return to a specific RRW or SAL stage, step or process in order to modify or improve the products and/or processes and associated files. In exemplary embodiments, if the student, user, founder or entrepreneur has passed the stages or met specific thresholds, the task queue 315 may provide the user's input from the prior RRW or SAL stages, steps and modules, along with the RRI score or value, into the AI tool invoker 320, which determines which AI software tool or agent to invoke or initiate next in the enhanced AI workflow process. As illustrative examples of the decision process implemented by the decision engine 310, if a RRW phase, step or module is II and a project or product formal specification file has been completed and if the gate or iterate phase, step or module of the SAL process identifies the user, student, founder or entrepreneur has passed, the decision engine 315 and/or the task queue may pass the user's output to the tool invoker 320, which may identify that a user interface or user experience software tool should be invoked (e.g., Lovable) because the user, founder or student's project or formal specification file is ready for user interface or user experience design. In another illustrative example, if a student or founder is in phase, step or module 3 (e.g., the build and deploy phase, step or module) of the RRW process, a calculated deployment error rate is greater than 0.2, then the decision engine 310 identifies this and/or the task queue 315 passes the student, founder or user (and associated digital files) via a rollback function back to a prior stage, step or module in the RRW or SAL process in order to improve the user's or founder's output and/or files and the task queue 315 may also communicate a message to a mentor of the user, founder and/or student. This communication may improve a user's or founder's morale. As an additional example, if after the third phase, step or module of the RRW process or RRI phase has been completed and the rules engine 310 identifies or determines that the RRI is greater than a threshold score (e.g., 65), the rules engine 310 my communicate with the task queue 315 and/or the tool invoker 320 to unlock an investor pitch elective module or tool in order to accelerate users or students that are excelling in the program (e.g., completing the steps of the enhanced AI workflow process).

In exemplary embodiments, the fifth process or the Enlightenment & Empowerment Mapping (EEM) process of an enhanced product AI workflow process may be implemented for the user or entrepreneur. In exemplary embodiments, the EEM or fifth process may be a multimodal framework that blends and/or combines neuroscience, generative-AI, and meta-physical practices or processes (Law of Attraction, gratitude journaling, astro-mapping) to accelerate in product or project presentation files (or identity-level change). These processes may include Law of Attraction, gratitude journaling and/or astro-mapping processes. There may be multiple processes or practices in the EEM process. Illustratively, each of these processes may include a stage or name, a process input, an AI/neurological technique, and/or a process output and feedback. For example, in a first EEM process referred to as an intent clarifier process, an input may include passion or personality vectors, an RRI snapshot (or snapshot value) and these inputs may be provided or formed into a GPT-4o Socratic prompts and MoSCoW sorting. In this first EEM process, the first EEM process may output a Clarity Map, which includes 3 North-Star goals. In a second EEM process (a vision former), the Clarity Map may be input in a DALL-E prompt set and/or Midjourney styles and a resulting output may be a HD vision board in either a PNG, PDF and/or VR-panorama format. In illustrative examples, in a third EEM process (an Astro Alignment process), birth data may be input into an Ephemeris Application Programming Interface (API) plus a GPT-4o synthesis module and the combination may output geo-hotspots and/or a place energy bullet list. In an illustrative example, in a fourth EEM process (e.g., an elevated emotion inducer), a desired feeling state value (e.g., a joy value, a gratitude value and/or a confidence value) may be input into as a LLM-written script which may then be input into a text-to-speech (TTS) voice clone and further into a binaural-beat mix. In exemplary embodiments, this fourth EEM process may output a 10-minute personalized meditation audio file. In another illustrative example, in a fifth EEM process (e.g., a neuro patterning loop process), a daily micro-journal or voice note file may be input a LLM sentiment & depth analysis module and/or a spaced-repetition scheduler module. In this illustrative example, the neuro-repatterning loop process may output one or more adaptive gratitude/affirmation prompts.

In an additional illustrative example, in a sixth EEM process (e.g., a subconscious feedback process or module), inputs may be received from wearable APIs (e.g., for sleep and HRV) and/or RRI delta values and placed or input into a reinforcement model that fine tunes prompts and audio cadence and then outputs bio-synched meditation files and/or habit nudges. In an additional illustrative example, in a seventh EEM process (e.g., a manifestation tracker process), a completed milestones file and synchronicities log files may be input into a LLM pattern recognition module (e.g., a law-of-attraction” events module). In this manifestation tracker process, the output may be an evidence log timeline file and/or celebratory AR confetti or celebration file. In a final illustrative example, in a seventh EEM process (e.g., an integration and share process), vision asset files, an astro map file and/or the evidence log files may be input into a Canva-style template generator. In this EEM process (the integration and share process), the output may be a social media share reel file and/or a PDF workbook file.

Career-Empowerment Pathway (CEP)—In exemplary embodiments, the sixth process or the Career-Empowerment Pathway (CEP) process of an enhanced product AI workflow process may be implemented for the user or entrepreneur. In exemplary embodiments, the CEP process may be an adaptive workflow that (i) assesses passions/skills, (ii) generates personalized career maps, (iii) provides AI-mentor coaching for resume building, and/or (iv) ranks candidates for donor-funded internships or entrepreneurship grants.

In exemplary embodiments, the CEP process has multiple phases, steps or modules, which may be an assessment intake phase, step or module, a role-fit scoring phase, step or module, a career map generator phase, step or module, a skill-gap planner phase, step or module, an AI mentor chatbot phase, step or module, a portfolio & proof builder phase, step or module, a candidate ranking engine phase, step or module, and/or an internship/grant match phase, step or module.

In exemplary embodiments, the assessment intake phase, step or module may receive passions, or passion value, skills, prior experience and/or an RRI snapshot value and input this into an adaptive questionnaire including LLM-generated follow-ups and/or vector embedding. This assessment intake phase, step or module may output a learner profile P vector or array, where the learner profile P vector or array includes a passion value, a skill value, an RRI value and/or a resume value (the values may also be referred to as tokens). In exemplary embodiments, a role-fit scoring phase, step or module may receive as an input the learner profile vector or array and this may be entered in k-NN against an ontology of technical and/or creative roles to generate a ranked list of n best fit career choices for the student or entrepreneur. In exemplary embodiments, a career map generator phase, step or module may receive as an input a top-rated career role which may be input as a CHAT GPT-4o prom set that references role competencies. In this embodiment, the career map generator phase, step or module may generate a JSON career map, which includes a skill gap, an AI-tool kit and/or software skill targets. In exemplary embodiments, a skill-gap planner phase, step or module may receive as an input the JSON career map and may initiate or execute a TCO rule module in order to map gaps based at least in part RRW and the VMEW modules. In exemplary embodiments, VMEW may equal a Vision-Mapping and Empowerment Workflow. In exemplary embodiments, the VMEW module or subroutine may be invoked in the TIR process or CEP process or module and may generate motivational and/or identify-reframing assets. These assets may include but are not limited to Ai-generated vision boards, personalized affirmation scripts, and/or empowerment toolkit outputs (e.g., such as AI-Resume Builder and/or journalling loops). The VMEW module or surface may also align with the EEM process or module (the previously described fifty process). In exemplary embodiments, the skill-gap planner phase or step may output a personalized learner pathway and the personalize learner pathway may include module identifiers (IDs) and/or associated due dates.

In exemplary embodiments, the AI mentor chatbot phase, step or module may receive a resume draft file and/or also receive interview responses received in response to interview prompts. In exemplary embodiments, the AI mentor chatbot phase, step or module may utilize an LLM rewriting module and/or a STAR method coaching module on the input resume draft and interview answers in order to generate iterative resume version files and/or mock-interview transcript files. In exemplary embodiments, a portfolio & proof builder phase, step or module may receive code repositories, design files and/or pitch deck files and input these repositories and files into Git/Drive APIs and/or a LLM summarizer module, which may output a public portfolio link for the student or entrepreneur and/or a 200 word (or specified length) “About Me” file. In exemplary embodiments, a candidate ranking engine phase, step or module may receive an updated RRI value and/or portfolio metric parameters or values. In exemplary embodiments, a gradient-boost model (or phase, step or module) may receive these inputs along with associated weights in order to generate a placement score from 0 to 1000. As an illustrative example, the weight values for the gradient-boost model may include a RRI weight of 0.4, a resume weight of 0.3 and/or a portfolio weight of 0.3. In exemplary embodiments, an internship and grant match phase step or module may receive a placement score from the candidate ranking engine phase, step or module may receive the placement score value and/or partner requirements and a stable matching algorithm may receive this input and generate an offer packet file for the student or entrepreneur or may provide a feedback loop with recommendations on which AI Agents or software platforms may be completed in order to upskill further and thus increase a students or entrepreneur's placement score value. Illustrative uses of the CEP process may include automatically calling the EEM phase, step or module if a student or entrepreneur requests a vision board and/or a motivation score greater than zero. In another illustrative example of use of the CEP process, placement score values may be automatically pushed to TIR cohorts utilizing anonymized identifiers (IDs). In an additional illustrative embodiment, some, many or all of the events of the CEP process may be output or emitted to the TCO process so that an downstream dashboards may be synchronized. In order to meet privacy and/or compliance requirements of specific systems or implementations, personally-identifiable information may be stripped or deleted from any output data and supplying of such output data to any partner-match API call, and in these cases, only hashed resume identifiers and portfolio URLs are transmitted.

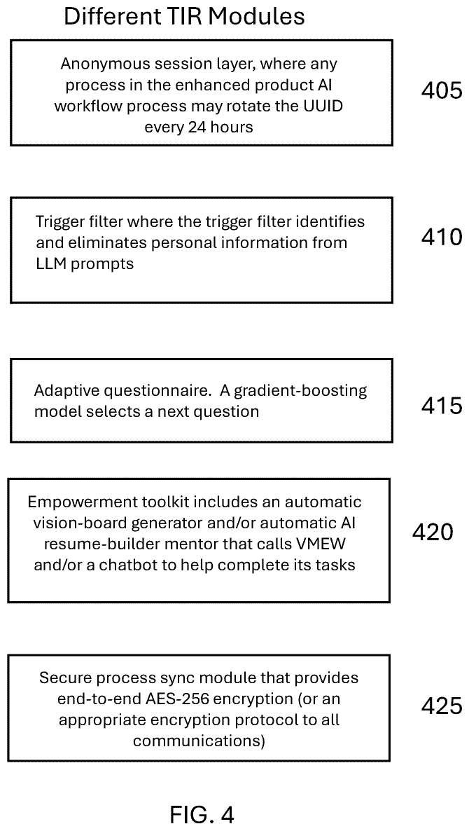

In exemplary embodiments, an additional process in an enhanced product AI workflow process may include a safeguarded mode adding anonymity, trigger filtering, and empowerment tools generation for victims of emotional, physical, and/or mental trauma, as well as underprivileged individuals & communities. This may be referred to as a Trauma-Informed Reintegration (TIR) module or process. In other words, the safeguard mode may be implemented with any of the other processes described above and/or below in order to protect vulnerable individuals from their identity or personally-identifiable information to be accessed. In exemplary embodiments, in order to be accessible to many different communities, multilingual resources may be utilized. These multilingual resources may be in languages such as Georgian, Romanian, Armenian and/or English languages. In exemplary embodiments, the safeguard mode may include different steps or processes. FIG. 4 illustrates a safeguard or Trauma Informed Reintegration process and module according to exemplary embodiments. In exemplary embodiments, a first phase, step or module 405 may include an anonymous session layer, where any process in the enhanced product AI workflow process may rotate the UUID every 24 hours, may redistribute the token store and may not include personally identifiable information (PII) in any payloads in the process. In exemplary embodiments, a second phase, step or module of the safeguard mode or TIR process 410, may include a trigger filter where the trigger filter identifies and eliminates personal information from LLM prompts. In other words, the trigger filter step or phase may classify and/or rewrite LLM outputs and/or inputs if a trigger score is greater or less than a predetermined value (e.g., <0.2). In exemplary embodiments, a third step, phase or module of the safeguard mode or TIR process may be a career path AI test 415 which includes an adaptive questionnaire. In this step, phase or module, a gradient-boosting model selects a next question. In exemplary embodiments, a fourth step, phase or module of the safeguard mode or TIR process 420 may be an empowerment toolkit. In these embodiments, the toolkit may include an automatic vision-board generator and/or automatic AI resume-builder mentor that calls VMEW and/or a chatbot to help complete its tasks. In exemplary embodiments, a fifth step, phase or module of the safeguard mode of the TIR process 425 may be a secure process sync module that provides end-to-end AES-256 encryption (or an appropriate encryption protocol to all communications). In exemplary embodiments, this fifth encryption (or secure product sync) step, phase or module may be synced when a device is online, whereas the enhanced AI process may also include an offline progressive web application (PWA) mode.

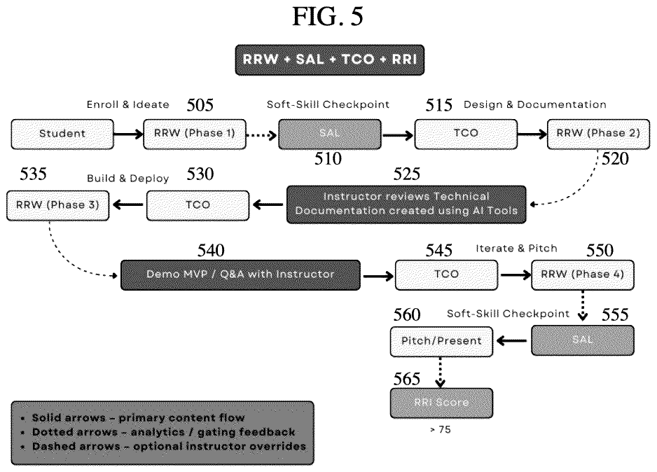

FIG. 5 illustrates an example implementation of many processes of an enhanced product AI workflow process for a representative organization according to exemplary embodiments. In an exemplary embodiment, the first organization an enhanced product AI workflow process may utilize elements of a RRW process, elements of a SAL process, elements of a TCO process and/or calculation of an RRI. In some embodiments, the entire or most of the enhanced product AI workflow process may be automated. In other embodiments, students may be guided by a combination of the automated RenAIssance system and an instructor or teacher. As illustrated by FIG. 5, a student may input project and/or product parameters into an ideation phase, step or module 505 of the RRW process and the ideation phase, step or module 505 may output a project or product pitch digital file. Sequentially or simultaneously idea or project or product pitch digital file (as well as personal information) may be input into a SAL phase, step or module 510 in order to generate a JSON blob or file). In exemplary embodiments, the output from the ideation phase, step or module 505 (e.g., the project or product pitch digital file) may be input into a first TCO process 515 in order to identify or determine what AI agent tool or software should be utilized to assist the student in the design and/or documentation stage of the RRW process. In exemplary embodiments, after the first TCO process 515 has determined or identified which AI agent tool or software to utilize to design and/or document the project or product pitch digital file, the design and documentation phase, step or module 520 may generate a project or product digital specification file. In exemplary embodiments, in step, phase or module 525, a software agent and/or an instructor may evaluate the project or product digital specification file to identify potential issues and/or problems. In exemplary embodiments, in step, phase or module 530, a second TCO process may receive the project or product digital specification file and determine a second AI agent tool or software to utilize to convert the project or product digital specification file. In exemplary embodiments, after the second TCO process has determined the second AI agent tool or software, in step, phase or module 535, the build and deploy phase, step or module may utilize the second AI agent tool or software to convert the project or product digital specification file into a most viable project digital file (or MVP digital file). In exemplary embodiments, in step 540, a student or entrepreneur may automatically demonstrate the MVP digital file to instructors or other software programs. In exemplary embodiments, in step 545, a third TCO process may evaluate the MVP digital file and determine a third AI agent tool or software to utilize in an iteration and/or pitch phase or step. In exemplary embodiments, after the third agent tool or software is selected, in step, phase or module 550, the iterate and pitch step, phase or module may automatically generate a project or product digital presentation file utilizing the third AI agent tool or software.

In exemplary embodiments, in step, phase or moule 555, an evaluate stage, step or module of the SAL process may automatically score the project or product digital presentation file and may generate clarity score values, confidence score values, creativity score values and/or empathy score values. In exemplary embodiments, the clarity score values, confidence score values, creativity score values and/or empathy score values may create an evaluation score vector which includes these values. In some cases, the third AI agent tool of software may utilize a BERT classifier, or GPT-4o evaluation process.

In exemplary embodiments, in step, phase or module 560, the user may pitch or present the project or product digital presentation file to executives and/or instructors. This may happen automatically by transmitting the project or product digital presentation file to executive or instructor computing devices, may happen over video conferencing, and/or may occur via an in-person presentation. In exemplary embodiments, in step, phase or module 565, a RenAIssance Readiness Index (RRI) may be calculated for the student or entrepreneur by utilizing a specified weighted algorithm and/or prompts that are input into the steps, phases or modules of the RRW process and/or the SAL process. In other embodiments, the project or product digital presentation file, the JSON blob, and/or scoring values from the SAL process described above may be utilized. In exemplary embodiments, the RRI value may be calculated based at least in part on prompt quality, code accuracy, deployment success and/or presentation sentiment of the items listed above. In exemplary embodiments, if the RRI score is greater than or equal to 75, the student or entrepreneur has created a successful presentation pitch.

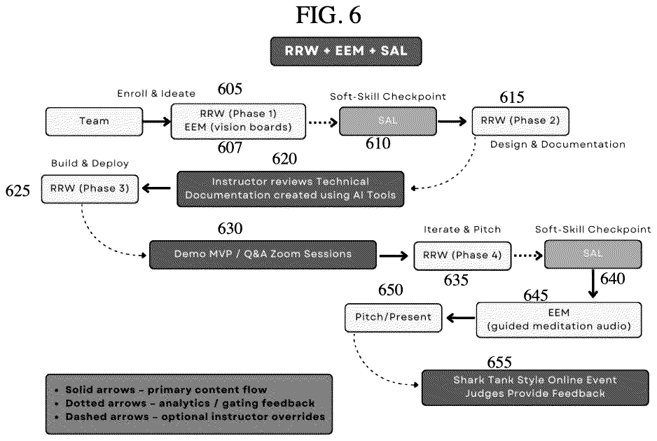

FIG. 6 illustrates a flowchart outlining implementation of many processes of an enhanced product AI workflow process for a representative organization according to exemplary embodiments. In exemplary embodiments, in step, phase or module 605, a student may input project and/or product parameters into a ideation phase, step or module 605 of the RRW process and the ideation phase, step or module 605 may output a project or product pitch digital file. In exemplary embodiments, in step, phase r module 607, a student or entrepreneur may receive a student goals and/or information, a first EEM process may output a Clarity Map, which includes 3 North-Star goals for a project and/or product. In a second EEM (or vision former process), a Clarity Map may be input in a DALL-E prompt set and/or Midjourney styles and a resulting output may be a HD vision board in either a PNG, PDF and/or VR-panorama format (e.g., a project or product vision board).

Sequentially or simultaneously idea or project or product pitch digital file (as well as personal information) may be input into a SAL phase, step or module 610 in order to generate a JSON blob or file).

In exemplary embodiments, the project or product pitch digital file may be input into the design and documentation phase, step or module 615 may generate a project or product digital formal specification or requirements file. In exemplary embodiments, in step, phase or module 620, a software agent and/or an instructor may evaluate the project or product digital specification file to identify potential issues and/or problems. In exemplary embodiments, in step, phase or module 625, the build and deploy phase or step may utilize a second AI agent tool or software to convert the project or product digital specification file into a most viable project digital file (or MVP digital file). In exemplary embodiments, in step, phase or module 630, a student or entrepreneur may automatically demonstrate the MVP digital file to instructors or other software programs and/or may participate in question and answer sessions to prepare for pitching the project and/or product. In exemplary embodiments, after the third agent tool or software is selected, in step, phase or module 635, the iterate and pitch step, phase or module may automatically generate a project or product digital presentation file utilizing the third AI agent tool or software.

In exemplary embodiments, in step, stage or module 640, an evaluate stage, step or module of the SAL process may automatically score the project or product digital presentation file and may generate clarity score values, confidence score values, creativity score values and/or empathy score values. In exemplary embodiments, the clarity score values, confidence score values, creativity score values and/or empathy score values may create an evaluation score vector which includes these values. In some cases, the third AI agent tool of software may utilize a BERT classifier, or GPT-4o evaluation process. In exemplary embodiments, in step, stage or module 645, in a fourth EEM process (e.g., an elevated emotion inducer process), a desired feeling state value (e.g., a joy value, a gratitude value and/or a confidence value) may be input into as a LLM-written script which may then be input into a text-to-speech (TTS) voice clone and further into a binaural-beat mix. In exemplary embodiments, this fourth EEM process may output a personalized meditation audio file. In exemplary embodiments, in step, stage or module 650, the user may pitch or present the project or product digital presentation file to executives and/or instructors. This may happen automatically by transmitting the project or product digital presentation file to executive or instructor computing devices, may happen over video conferencing, and/or may occur via an in-person presentation. In exemplary embodiments, in step, stage or module 655, a student or entrepreneur may present the project or product digital presentation file to a number of judges in a “Shark Tank” style online event where a number of judges may provide verbal and/or digital feedback on the project or product digital presentation file. FIG. 6 may be utilized by women-led teams eager to create STEM-related projects, gained access to private zoom sessions, where instructors and AI tools implement RRW to go from project or product parameters to a MVP digital file, while also learning how to create effective project or product digital presentation files and how to present in front of an audience. In the example illustrated in FIG. 6, Vision-boards may be created and published via EEM on a second day which became a narrative spine for Demo Day pitches (e.g., the project or product digital presentation files). In exemplary embodiments, in this example, an idea-to-demonstration time for the project or product digital presentation file dropped by 50 percent and experts provided extremely positive feedback.

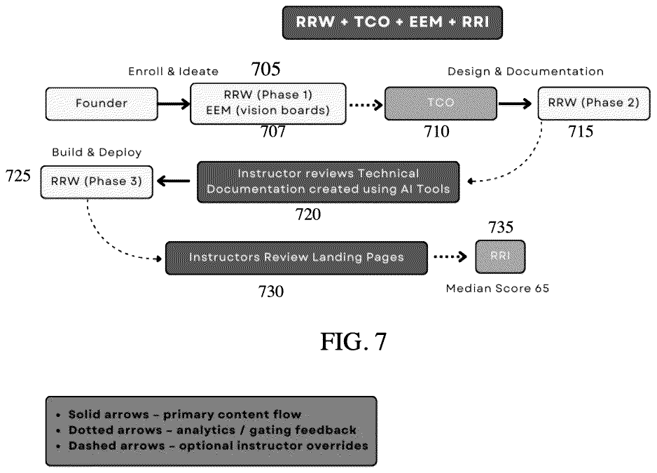

FIG. 7 illustrates a flowchart outlining implementation of many processes of an enhanced product AI workflow process for a representative organization according to exemplary embodiments. In exemplary embodiments, in step, phase or module 705, a student or founder may input project and/or product parameters into a ideation phase, step or module 705 of the RRW process and the ideation phase or step 705 may output a project or product pitch digital file. In exemplary embodiments, in step, phase or module 707, a student or founder may receive a founder goals and/or information, a first EEM process may output a Clarity Map, which includes 3 North-Star goals for a project and/or product. In a second EEM (or vision former process), a Clarity Map may be input in a DALL-E prompt set and/or Midjourney styles and a resulting output may be a HD vision board in either a PNG, PDF and/or VR-panorama format (e.g., a project or product vision board).

In exemplary embodiments, the output from the ideation phase, step or module 705 (e.g., the project or product pitch digital file) may be input into a first TCO process 710 in order to identify or determine what AI agent tool should be utilized to assist the student in the design and/or documentation stage of the RRW process. In exemplary embodiments, after the first TCO process 710 has determined or identified which AI agent tool or software to utilize to design and/or document the project or product pitch digital file, the design and documentation phase, step or module 715 may generate a founder project or product digital specification file. In exemplary embodiments, in step, phase or module 720, a software agent and/or an instructor may evaluate the project or product digital specification file to identify potential issues and/or problems. In exemplary embodiments, in step, phase or module 725, the build and deploy phase or step may utilize a second AI agent tool or software to convert the project or product digital specification file into a most viable project digital file (or MVP digital file), which may include landing pages for a web site of the MVP digital file. In exemplary embodiments, in step 730, a third AI agent or software and/or an instructor may analyze and/or review the generated landing pages. In exemplary embodiments, in step, phase or module 735, a RenAIssance Readiness Index (RRI) may be calculated for the student or founder by utilizing a specified weighted algorithm and/or the project or product digital presentation file. In exemplary embodiments, the RRI may be calculated based at least in part on prompt quality, code accuracy, deployment success and/or presentation sentiment of the items listed above. In exemplary embodiments, if the RRI score is greater than or equal to 65, the student or entrepreneur has created a successful presentation pitch.

As an illustrative example of a utilization of the AI enhanced process in FIG. 7, thirty creatives may meet in a pop-up “Micro-Soho House.” In this illustrative example, many of the modules identified above ran in automated mode and/or some modules utilized live instructors. Other modules may have run in kiosk mode. In exemplary embodiments, EEM stations or modules may automatically generate astro-maps that attendees or founders incorporated into the generated vision boards. In exemplary embodiments, utilizing the processes or modules identified above, the micro-startups founders or personnel generated functioning landing pages and had a median RRI of 63.

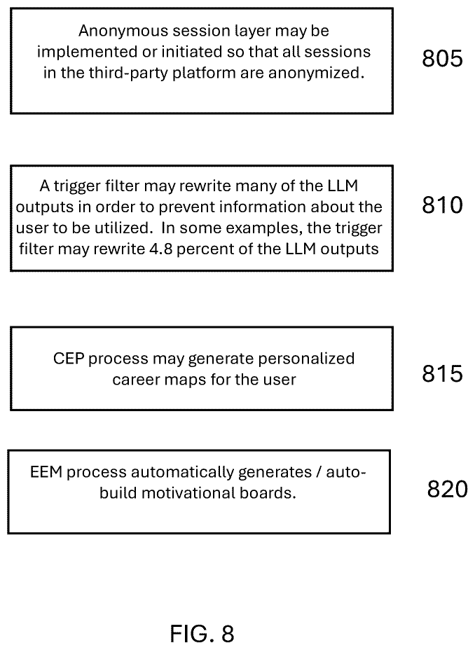

FIG. 8 illustrates a trauma—informed reintegration pilot process according to exemplary embodiments. In exemplary embodiments, a larger number of domestic-violence survivors using a third-party software platform may have a safeguard mode enabled in a trauma-informed reintegration module that is integrated into the third-party software platform. In exemplary embodiments, in step, phase or module 805, an anonymous session layer may be implemented or initiated so that all sessions in the third-party platform are anonymized. In exemplary embodiments, in step, phase or module 810, a trigger filter may rewrite many of the LLM outputs in order to prevent information about the user to be utilized. In some examples, the trigger filter may rewrite 4.8 percent of the LLM outputs. In exemplary embodiments, in step, phase or module 815, the CEP process may generate personalized career maps for the user. In exemplary embodiments, in step, phase or module 820, utilizing the EEM process, the EEM process may automatically generate and/or auto-build motivational boards. In exemplary embodiments, the personalized career maps and/or the EEM maps may be utilized by the user to obtain internships or career opportunities.

There are other implementations of many different processes depending upon the environment and/or situation an entity faces. As an illustrative example, in environments where connectivity is not available (e.g., an offline mode) or where there is a secure local sever, a localized Tool Chain Orchestrator (TCO) may be a self-contained rules engine may be running locally on a user or student's device (or on the secure local server). This allows users or students or founders to have AI-tool sequencing and/or data capture without continuous cloud connectivity. This is a unique and novel feature to allow students and users to continue using one or more processes of the enhanced AI workflow process. In exemplary embodiments, a Offline PWA Fallback feature in the enhanced AI workflow process refers to a Progressive Web Application mode that caches all orchestration rules, learner telemetry, and task queues locally, which allows uninterrupted operation during network loss. The Offline PWA Fallback feature then synchronizes to a central system or platform database once network connectivity resumes. Thus, in these exemplary embodiments, the entire adaptive workflow may now run autonomously (and/or automatically) in disconnected embodiments. different processes in the enhanced AI workflow process Automation-only: Attendees chose new “launch cities” based on EEM insights; three projects entered the 301 AD alumni incubator.

In some exemplary embodiments, certain processes of the enhanced AI workflow process may be scaled down in environments where specific features are required and/or requested, but complexity is not ideal. One of these environments may be elementary or middle schools. In these embodiments, which may be referred to as a Public-School Micro-Course Pilot, the TCO process was limited or throttled to reduce complexity for middle school students. In the Public-School Micro-Course pilot, a limited version of the RRW process, the SAL process and the TCO process were provided and the RRI process was also utilized. The limited version of the RRW process may be referred to as RRW-Mirco and may be a condensed two-phase version of the four-phase RRW process used for the younger students. The RRW-Micro process limits the accessible tools to low-complexity modules (only ChatGPT-Voice, Replit, and Gamma were utilized or unlocked). The condensed two-phase process also omits advanced deployment or investor-pitch functionality in the RRW process. The limited SAL process may be referred to as the SAL-Lite process. In this limited or reduced complexity variant of the SAL-Lite process that evaluates only group storytelling clarity and collaboration confidence, rather than the full scoring vector (e.g., clarity, confidence, creativity and/or empathy). Both the RRW-Micro and the SAL-Lite variants throttle the complexity while maintaining measurable soft-skill data capture. In exemplary embodiments, soft-skill checkpoints measured group storytelling and average RRI reached 38, which may be utilized as baseline data for future STEM grants. As noted previously, these RRW-Micro, SAL-Lite and/or throttled TCO processes may be software or computer-readable instructions executable by one or more processors of computing devices.

In exemplary embodiments, processes that are part of the enhanced AI workflow process may be integrated into other learning systems and/or software platforms. As an illustrative example, an outsourcing company integrated a TCO rules engine (e.g. software or module) into its proprietary Learning Management System (LMS). In thin automatic sequencing of internal training modules and/or capture of RRI-related metrics (e.g., prompt quality, code accuracy, deployment logs or assessment and/or presentation sentiment) within the LMS. In this example, TCO event data was communicated or transferred to HR dashboards for automated performance ranking and promotion readiness. In this example, an RRI greater than 70 resulted in higher performance ranking and promotion readiness. In this example, after four weeks, billable productivity rose 22 %. The example described herein demonstrates enterprise-level interoperability of the TCO process within third-party learning ecosystems with positive results.

The enhanced AI process and the steps or phases described herein provide many benefits to students, founders and/or entrepreneurs. As an illustrative example, the RRW process and/or the TCO process may be implemented in coding bootcamps in order to generate most viable product digital files and/or applications. In this example, the coding required to create or generate MVP digital files and/or applications may be reduced by seventy-five (75) percent. In other examples, the utilization of the SAL and/or RRI processes may product quantified growth and/or significant and substantial SAL clarify gains. In other examples, the TCO may result in extremely personalized tools for the student, founder or entrepreneur and may adapt per a learner mastery. In exemplary embodiments, the utilization of the EEM and/or RRW processes results in a streamlined vision-to-product pipeline with an investor-ready pitch (or presentation digital file). In exemplary embodiments, the TIR process may result in Anonymous, encrypted learning for vulnerable users. In exemplary embodiments, the CEP process may allow data-driven matches to donor-funded roles and thus career mobility. In exemplary embodiments, the multi-lingual aspect of the EEM process and astro-guided relocation insights in the enhanced AI process enhance a global appears of the enhanced AI process. The steps and phases of the enhanced AI process allow the enhanced AI process to be scalable and/or licensable in separate modules and/or in total. In other words, the steps and/or phases of the enhanced AI process results in scalable and tool-agnostic curricula licensable (e.g., white-labeled) to elementary schools, middle schools, high schools, colleges, universities, corporations, and/or NGOs.

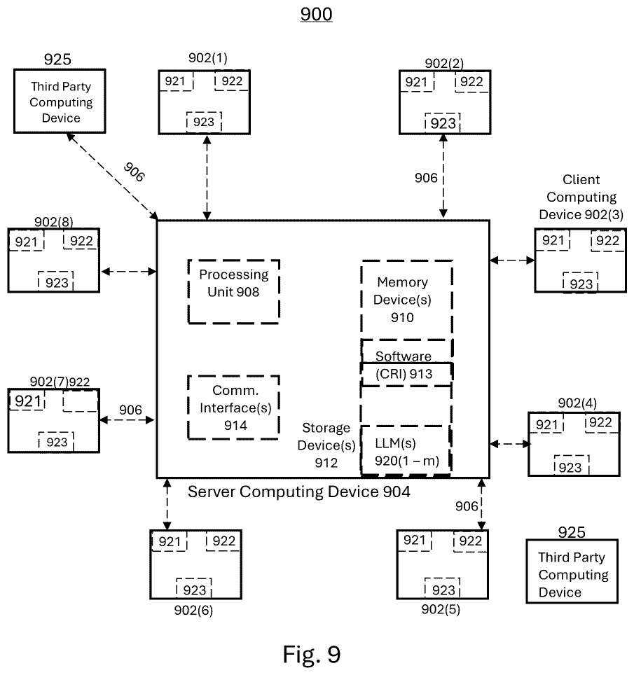

FIG. 9 illustrates a block diagram of a computing environment according to exemplary embodiments. With respect to FIG. 9, a computing environment 900 includes a plurality of client computing devices 902(1)-902(N) communicatively coupled to one or more server computing device(s) 904 via a communications network 906. In exemplary embodiments, the communications network 906 may include one or more of a local area network (LAN), wide area network (WAN), or the Internet. In exemplary embodiments, the communications network 906 may communicate via electrical communications and/or optical communications and may be wired (e.g., connected or coupled together) or wireless (e.g., connected or coupled together). The processes, steps and phases and associated software described herein would be executing and/or running within the computing environment described herein.

Each client computing device 902(1-N) may include one or more processors 921, one of memory devices 922, and one or more interfaces 923 for transmitting data to and from the one or more server computing device(s) 904. The client computing devices 902(1-N) may execute applications configured to submit input data, receive model outputs, initiate training sessions, or monitor model performance. These applications include the processes, steps, phases, modules and/or associated files described in FIGS. 1-8 above. In exemplary embodiments, students, founders and/or entrepreneurs may each have a client computing device 902(1-N) in order to interact and/or interface with the one or more server computing devices 904. In exemplary embodiments, the one or more server computing device(s) 904 may comprise one or more processing units 908, one or more memory devices 910, one or more storage devices 912, and one or more communication interfaces 914. In exemplary embodiments, the one or more storage devices 912 and/or the one or more memory devices 910 may hold, store and/or maintain the software modules corresponding to and associated with the processes, steps and/or phases of the enhanced AI workflow process described in FIGS. 1-8 above. In some embodiments, third party computing devices 925 may have third party AI agent or software programs residing therein and the one or more server computing device(s) 904 may communicate with the third-party computing devices 925 over the one or more communication interfaces 914. These third-party computing devices may include third-party software, AI agents, and/or LLMs such as ChatGPT, Canva, Gemini, etc. In other embodiments, the one or more storage devices 912 and/or the one or more memory devices 910 may store local copies of the third-party AI agents or software for ease of use and/or quicker access by the enhanced AI workflow process. In exemplary embodiments, the one or more storage devices 912 and/or the one or more memory devices 910 may maintain one or more sets of large language learning modules 920(1)-920(M) that are utilized by the local AI software agents and/or software. In other embodiments, the LLMs may reside on the one or more third party server or computing devices. In some embodiments, each large language learning module 920 includes a parameterized model architecture, training parameters, and associated data pipelines for executing machine learning tasks such as natural language understanding, generation, or translation. Each large language learning module 920 may include a neural network architecture comprising an embedding layer, one or more attention layers, and an output layer configured to generate text-based predictions. The modules may differ in architecture, parameter size, or task specialization (e.g., summarization module, code generation module, sentiment analysis module). In exemplary embodiments, for any software programs and/or AI agents residing in the one or more server computing devices 904 may execute computer-readable instructions executable by the one or more processors or processing units 908 installed therein to perform features and/or functions of the different processes, steps and/or phases of the enhanced AI workflow process.

In exemplary embodiments, a computer-implemented method of generating a product or project presentation digital file and associated software application includes accessing computer-readable instructions from one or more memory devices in one or more computing devices; executing, by one or more processors, the computer-readable instructions to cause the one or more computing devices to: generate, during a foundation or iteration step of a readiness workflow process, a project or product pitch file; evaluate, utilizing a soft-skill accelerator loop process, the project or product pitch digital file to determine a vector score or value for the project or product pitch digital file; determine, via a tool chain orchestrator process, a next artificial intelligence (AI) software tool or agent to initiate, execute or deploy with respect to the project or product pitch digital file; generate, in a design or development phase of the readiness workflow process, a project or product formal specification file based at least in part on the project or product pitch digital file; automatically review the project or product formal specification file to determine quality parameters associated with the project or product formal specification file; determine, via the tool chain orchestrator process, a second AI software tool or agent for a build and deployment phase to perform operations on the project or product formal specification file; and generate, via the build and deployment stage of the readiness workflow process, the most viable product (MVP) digital file from the project or product file formal specification file. In exemplary embodiments, the method may further include one or more processors executing computer-readable instructions to cause the computing device to: determine, via the tool chain orchestrator process, a third AI software tool or agent, to utilize during an iteration or pitch phase; and automatically generate, via the pitch and iteration phase, the product or project presentation digital file based at least in part on the MVP digital file. In exemplary embodiments, the method may further include the one or more processors executing computer-readable instructions to cause the computing device to: present the project or product presentation digital file to third-parties; and receive feedback scoring values from computing devices associated with the third-parties. In exemplary embodiments, the method may further include one or more processors executing computer-readable instructions to cause the computing device to: automatically calculate, via an evaluation stage of the SAL process, scoring values for the project or product presentation digital file, the scoring values including clarity score values; confidence score values, creativity score values and empathy score values. In exemplary embodiments, the method may further include one or more processors executing computer-readable instructions to cause the computing device to: automatically calculate, via a readiness index process, a readiness index score based at least in part on a plurality of prompts generated during the readiness workflow process; and determine success of the project or product presentation digital file by comparing the readiness index score to a specified readiness threshold. In exemplary embodiments, a plurality of prompts generated during the readiness workflow process are in a format of prompt_text, response_text, timestamps, and learner_ID.

In exemplary embodiments, a computer-implemented method of generating a product or project presentation digital file and associated software application includes accessing computer-readable instructions from one or more memory devices in one or more computing devices; executing, by one or more processors, the computer-readable instructions to cause the one or more computing devices to: generate, during a foundation or iteration step of a readiness workflow process, a project or product pitch file; receive student goals and/or the project or product pitch file; output a clarity map including two or more goals for a project or product associated with the product pitch file; input the clarity map to an artificial intelligent agent in order to generate a high-definition vision board file; evaluate, utilizing a soft-skill accelerator loop process, the project or product pitch digital file to determine a vector score or value for the project or product pitch digital file; determine, via a tool chain orchestrator process, a next artificial intelligence (AI) software tool or agent to initiate, execute or deploy with respect to the project or product pitch digital file; generate, in a design or development phase of the readiness workflow process, a project or product formal specification file based at least in part on the project or product pitch digital file; automatically review the project or product formal specification file to determine quality parameters associated with the project or product formal specification file; determine, via the tool chain orchestrator process, a second AI software tool or agent for a build and deployment phase to perform operations on the project or product formal specification file; and generate, via the build and deployment stage of the readiness workflow process, the most viable product (MVP) digital file from the project or product file formal specification file.

In exemplary embodiments, the one or more processors may execute computer-readable instructions to cause the computing device to: determine, via the tool chain orchestrator process, a third AI software tool or agent utilize during an iteration or pitch phase of the readiness workflow process; and automatically generate, via the pitch and iteration phase, the product or project presentation digital file based at least in part on the MVP digital file. In exemplary embodiments, the one or more processors may execute computer-readable instructions to cause the computing device to present the project or product presentation digital file to third-parties; and receive feedback scoring values from computing devices associated with the third-parties. In exemplary embodiments, the one or more processors may execute computer-readable instructions to cause the computing device to automatically calculate, via an evaluation stage of the SAL process, scoring values for the project or product presentation digital file, the scoring values including clarity score values; confidence score values, creativity score values and empathy score values. In exemplary embodiments, the one or more processors may execute computer-readable instructions to cause the computing device to automatically calculate, via a readiness index process, a readiness index score based at least in part on a plurality of prompts generated during the readiness workflow process; and compare the readiness index score to a specified readiness threshold to determine next steps in a computer-implemented method. In exemplary embodiments, the plurality of prompts are in a format of prompt_text, response_text, timestamps, and learner_ID.

In exemplary embodiments, a computer-implemented method of generating a product or project presentation digital file and associated software application includes accessing computer-readable instructions from one or more memory devices in one or more computing devices; executing, by one or more processors, the computer-readable instructions to cause the one or more computing devices to: generate, during a foundation or iteration step of a readiness workflow process, a project or product pitch file; receive student goals and/or the project or product pitch file; output a clarity map including two or more goals for a project or product associated with the product pitch file; input the clarity map to an artificial intelligent agent in order to generate a high-definition vision board file; evaluate, utilizing a soft-skill accelerator loop process, the project or product pitch digital file to determine a vector score or value for the project or product pitch digital file; determine, via a tool chain orchestrator process, a next artificial intelligence (AI) software tool or agent to initiate, execute or deploy with respect to the project or product pitch digital file; generate, in a design or development phase of the readiness workflow process, a project or product formal specification file based at least in part on the project or product pitch digital file; automatically review the project or product formal specification file to determine quality parameters associated with the project or product formal specification file; determine, via the tool chain orchestrator process, a second AI software tool or agent for a build and deployment phase to perform operations on the project or product formal specification file; and generate, utilizing the second AI software tool or agent, the most viable product (MVP) digital file from the project or product file formal specification file. In exemplary embodiments, the computer-readable instructions may be executable to automatically generate landing pages and the product or project presentation digital file based at least in part on the MVP digital file. In exemplary embodiments, the one or more processors may execute computer-readable instructions to analyze the generated landing pages. In exemplary embodiments, the one or more processors may execute the computer-readable instructions to automatically calculate, via a readiness index process, a readiness index score based at least in part on prompt quality, code accuracy, deployment success and/or presentation sentiment of a plurality of prompts generated during the readiness workflow process. In exemplary embodiments, the one or more prompts may be in a format of prompt_text, response_text, timestamps, and learner_ID.

As detailed above, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step.

In addition, one or more of the devices described herein may transform data, physical devices, and/or representations of physical devices from one form to another. For example, one or more of the devices recited herein may receive image data of a sample to be transformed, transform the image data, output a result of the transformation to determine a 3D process, use the result of the transformation to perform the 3D process, and store the result of the transformation to produce an output image of the sample. Additionally or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and shall have the same meaning as the word “comprising.

The processor as disclosed herein can be configured with instructions to perform any one or more steps of any method as disclosed herein.

As used herein, the term “or” is used inclusively to refer items in the alternative and in combination.

As used herein, characters such as numerals refer to like elements.

Embodiments of the present disclosure have been shown and described as set forth herein and are provided by way of example only. One of ordinary skill in the art will recognize numerous adaptations, changes, variations and substitutions without departing from the scope of the present disclosure. Several alternatives and combinations of the embodiments disclosed herein may be utilized without departing from the scope of the present disclosure and the inventions disclosed herein. Therefore, the scope of the presently disclosed inventions shall be defined solely by the scope of the appended claims and the equivalents thereof.

What is claimed is:

1. A computer-implemented method of generating a product or project presentation digital file and associated software application:
accessing computer-readable instructions from one or more memory devices in one or more computing devices;
executing, by one or more processors, the computer-readable instructions to cause the one or more computing devices to:
generate, during a foundation or iteration step of a readiness workflow process, a project or product pitch file;
evaluate, utilizing a soft-skill accelerator loop process, the project or product pitch digital file to determine a vector score or value for the project or product pitch digital file;
determine, via a tool chain orchestrator process, a next artificial intelligence (AI) software tool or agent to initiate, execute or deploy with respect to the project or product pitch digital file;
generate, in a design or development phase of the readiness workflow process, a project or product formal specification file based at least in part on the project or product pitch digital file;
automatically review the project or product formal specification file to determine quality parameters associated with the project or product formal specification file;
determine, via the tool chain orchestrator process, a second AI software tool or agent for a build and deployment phase to perform operations on the project or product formal specification file; and
generate, via the build and deployment stage of the readiness workflow process, the most viable product (MVP) digital file from the project or product file formal specification file.

2. The method of claim 1, the one or more processors executing computer-readable instructions to cause the computing device to:
determine, via the tool chain orchestrator process, a third AI software tool or agent, to utilize during an iteration or pitch phase; and
automatically generate, via the pitch and iteration phase, the product or project presentation digital file based at least in part on the MVP digital file.

3. The method of claim 2, the one or more processors executing computer-readable instructions to cause the computing device to:
present the project or product presentation digital file to one or more third-parties; and
receive feedback scoring values from computing devices associated with the one or more third-parties.

4. The method of claim 3, the one or more processors executing computer-readable instructions to cause the computing device to:
automatically calculate, via an evaluation stage of the SAL process, scoring values for the project or product presentation digital file or the prompts utilized in the RRW process and/or the SAL process, the scoring values including clarity score values; confidence score values, creativity score values and/or empathy score values.

5. The method of claim 4, the one or more processors executing computer-readable instructions to cause the computing device to:
automatically calculate, via a readiness index process, a readiness index score based at least in part on a plurality of prompts generated during the readiness workflow process; and
determine success of the project or product presentation digital file by comparing the readiness index score to a specified readiness threshold.

6. The method of claim 5, of a plurality of prompts generated during the readiness workflow process are in a format of prompt_text, response_text, timestamps, and learner_ID.

7. A computer-implemented method of generating a product or project presentation digital file and associated software application:
accessing computer-readable instructions from one or more memory devices in one or more computing devices;
executing, by one or more processors, the computer-readable instructions to cause the one or more computing devices to:
generate, during a foundation or iteration step of a readiness workflow process, a project or product pitch file;
receive student goals and/or the project or product pitch file;
output a clarity map including two or more goals for a project or product associated with the product pitch file;
input the clarity map to an artificial intelligent agent in order to generate a high-definition vision board file;
evaluate, utilizing a soft-skill accelerator loop process, the project or product pitch digital file to determine a vector score or value for the project or product pitch digital file;
determine, via a tool chain orchestrator process, a next artificial intelligence (AI) software tool or agent to initiate, execute or deploy with respect to the project or product pitch digital file;
generate, in a design or development phase of the readiness workflow process, a project or product formal specification file based at least in part on the project or product pitch digital file;
automatically review the project or product formal specification file to determine quality parameters associated with the project or product formal specification file;
determine, via the tool chain orchestrator process, a second AI software tool or agent for a build and deployment phase to perform operations on the project or product formal specification file; and
generate, via the build and deployment stage of the readiness workflow process, the most viable product (MVP) digital file from the project or product file formal specification file.

8. The method of claim 7, the one or more processors executing computer-readable instructions to cause the computing device to:
determine, via the tool chain orchestrator process, a third AI software tool or agent utilize during an iteration or pitch phase of the readiness workflow process; and
automatically generate, via the pitch and iteration phase, the product or project presentation digital file based at least in part on the MVP digital file.

9. The method of claim 8, the one or more processors executing computer-readable instructions to cause the computing device to:
present the project or product presentation digital file to third-parties; and
receive feedback scoring values from computing devices associated with the third-parties.

10. The method of claim 9, the one or more processors executing computer-readable instructions to cause the computing device to:
automatically calculate, via an evaluation stage of the SAL process, scoring values for the project or product presentation digital file, the scoring values including clarity score values; confidence score values, creativity score values and empathy score values.

11. The method of claim 10, the one or more processors executing computer-readable instructions to cause the computing device to:
automatically calculate, via a readiness index process, a readiness index score based at least in part on a plurality of prompts generated during the readiness workflow process; and
comparing the readiness index score to a specified readiness threshold to determine next steps in a computer-implemented method.

12. The method of claim 11, wherein the plurality of prompts are in a format of prompt_text, response_text, timestamps, and learner_ID.

13. A computer-implemented method of generating a product or project presentation digital file and associated software application:
accessing computer-readable instructions from one or more memory devices in one or more computing devices;
executing, by one or more processors, the computer-readable instructions to cause the one or more computing devices to:
generate, during a foundation or iteration step of a readiness workflow process, a project or product pitch file;
receive student goals and/or the project or product pitch file;
output a clarity map including two or more goals for a project or product associated with the product pitch file;
input the clarity map to an artificial intelligent agent in order to generate a high-definition vision board file;
evaluate, utilizing a soft-skill accelerator loop process, the project or product pitch digital file to determine a vector score or value for the project or product pitch digital file;
determine, via a tool chain orchestrator process, a next artificial intelligence (AI) software tool or agent to initiate, execute or deploy with respect to the project or product pitch digital file;
generate, in a design or development phase of the readiness workflow process, a project or product formal specification file based at least in part on the project or product pitch digital file;
automatically review the project or product formal specification file to determine quality parameters associated with the project or product formal specification file;
determine, via the tool chain orchestrator process, a second AI software tool or agent for a build and deployment phase to perform operations on the project or product formal specification file; and
generate, utilizing the second AI software tool or agent, the most viable product (MVP) digital file from the project or product file formal specification file.

14. The method of claim 13, the one or more processors executing computer-readable instructions to cause the computing device to:
automatically generate landing pages and the product or project presentation digital file based at least in part on the MVP digital file.

15. The method of claim 14, the one or more processors executing computer-readable instructions to cause the computing device to:
analyze the generated landing pages.

16. The method of claim 15, the one or more processors executing computer-readable instructions to cause the computing device to:
automatically calculate, via a readiness index process, a readiness index score based at least in part on prompt quality, code accuracy, deployment success and/or presentation sentiment of a plurality of prompts generated during the readiness workflow process.

17. The method of claim 16, wherein the one or more prompts are in a format of prompt_text, response_text, timestamps, and learner_ID.
